(19) United States
(12) Patent Application Publication
(10) Pub. No.: US 2004/0259992 A1
(43) Pub. Date: Dec. 23, 2004

(54) Adhesives for metal-polymer composites

(76) Inventor: Roland Gobel, Jena (DE)

Correspondence Address: MUETING, RAASCH & GEBHARDT, P.A., P.O. BOX 581415, MINNEAPOLIS, MN, 55458, US

(21) Appl. No.: 10/470,214

(22) PCT Filed: Jan. 25, 2002
(86) PCT No.: PCT/EP02/00798

(30) Foreign Application Priority Data
Jan. 26, 2001 (DE) 101 03 586.1

(51) Int. Cl. B05D 1/36; C07G 1/00; C08K 5/24

(52) U.S. Cl. 524/261; 427/402; 106/287.13; 106/287.15; 106/287.16

(57) ABSTRACT

The present invention relates to adhesion promoters for metal/polymer bonds that comprise alkoxysilanes having olefinically unsaturated double bonds and alkoxysilanes having mercapto groups, to their use and to metal/polymer bonds produced therewith.

The present invention relates to adhesion promoters for metal/polymer bonds that comprise alkoxysilanes having olefinically unsaturated double bonds and alkoxysilanes having mercapto groups, to their use and to metal/polymer bonds prepared therewith. In the field of dentistry, aesthetic appearance and functionality are inseparably linked to one another. In particular, the appearance of dental prosthesis materials must fulfil both requirements to a high degree, since on the one hand the dental prosthesis needs to assume the functions of the dental material originally present and on the other hand at the very least the dental prosthesis material should not worsen the outward appearance of its wearer. Metals or metal alloys or metal compositions referred to as “dental alloys” are frequently used as base materials for dental prosthesis materials. Because the colour of such metals or metal alloys differs from the normal colour of teeth, however, their visual appearance in the mouth is frequently perceived as intrusive and aesthetically unattractive.

If dental prostheses, for example prosthetic metal structures such as crowns and bridges, are to have an optimum aesthetic appearance it is therefore necessary to provide the surface of the metals or metal alloys used for that purpose with a tooth-coloured veneer, for example a plastics veneer. The bond between metal and veneer needs to meet high standards, however. For example, it is especially important that the veneers in question are bonded to the metals lastingly and without gaps. A defective bond results in premature detachment of the veneer or in the formation of gaps at the edges which, especially in the case of plastics veneers, may lead to discoloration of the edge as a result of oxidation of the metal structure and to mechanical irritation in the area of the gap between the veneer and the metal structure.

Furthermore, a metal/plastics bond, as in the case of plastics veneers, is subject to particular stresses in the oral environment. Such stresses are firstly physico-mechanical stresses, as occur during chewing movements. Secondly, chemical or biological stresses also arise in the oral environment, for example as a result of saliva, food or medicaments. The changes in temperature which also occur in the oral environment exert further mechanical stress on the bond. Under the extreme conditions of the oral environment, the constant changes in moisture and temperature and the mechanical stress on the bond, anchorings of the kind known hitherto for fixing the veneer to the metal to be veneered have often proved incapable of maintaining a bond between a dental alloy and a plastics veneer that is sufficiently stable over a prolonged period.

In the past, the customary method in dentistry for the production of a bond between metals and plastics materials was, for example, to use mechanical retainers, such as are obtainable by the application of beads or lattices to the metal. The disadvantages of such a system are firstly the purely mechanical bond, which always leads to gaps between the metal and the plastics veneer in the edge regions, and secondly the additional space required for the retainers, which creates serious problems in respect of the visual appearance during subsequent veneering.

Previous solutions without mechanical retainers either result in bonds having inadequate longevity or require a high level of equipment that is frequently unacceptable in dental laboratories.

In recent years, numerous methods of obtaining strongly adherent, moisture-stable and gap-free bonding of dental plastics to dental alloys have been proposed. The basic principle of many of the proposed methods is that in a first step a silicate layer is applied to the metal surface to be veneered (silicatisation) and in a further step that surface is provided with a functional alkoxysilane (silanisation), the functional alkoxy-silane acting as bonding element between the inorganic silicate layer applied to the metal surface and the plastics used for the veneer. This is achieved by the fact that the OH groups of the functional alkoxysilane become covalently bonded to the OH groups present on the surface of the silicate layer in the context of a condensation reaction, while on the other hand a further functional group present in the functional alkoxy-silane is able to react with the plastics used for the veneer, likewise with the formation of a covalent bond.

For example, DE-C1 34 03 894 describes a device for coating a metallic dental prosthetic and a method of operating such a device, wherein a flame hydrolysis burner is used for coating a metallic dental prosthetic with an adhesion promoter layer that contains silicon oxide, the flame hydrolysis burner being positioned at a maximum distance of 50 mm from the dental prosthetic. The flame hydrolysis burner is supplied with metered amounts of a hydrolysable silicon compound in a gaseous state of aggregation. A problem of the described method is that an extremely large amount of equipment is required and, furthermore, disadvantages arise in respect of the adhesive strength of the bond between metal and veneer.

DE-C1 38 02 043 describes a method of preparing a metal surface for bonding to plastics by the application of a silicon-containing layer using silicon-containing material. In that method a layer is applied to a metal surface by corundum-blasting with a medium containing from 0.1 to 30% by weight of optionally silanised amorphous silicon-containing material having a particle size <1 μm and as remainder a corundum blasting medium having an average particle size >1 μm and that layer is optionally then silanised. The adhesive strength of a bond created on such a surface is not, however, always fully satisfactory.

U.S. Pat. No. 4,364,731 discloses a method for applying a silicon dioxide layer to metallic dental prosthetics in which a high-frequency magnetron sputtering device is used. In addition to the large amount of apparatus required for carrying out the described method, the metal/polymer bonds obtainable have the disadvantage that they frequently do not exhibit sufficient adhesion values.

DD-A1 276 453 describes a method for the production of a metal/plastics composite in which a silicate/chromium oxide layer is applied to the surface of a dental alloy using a sol/gel solution and is solidified by a subsequent thermal treatment process.

Especially in the case of the described methods that employ the high-frequency magnetron sputtering device, the flame hydrolysis burner and the sol/gel method, temperatures of about 300° C. are required to obtain strongly adherent bonding of the bonded layer to the surface of the alloy. For a large number of metal alloys, however, such high temperatures have an adverse effect. For example, in the case of metal alloys having a copper content of more than 5%, such thermal stress leads to dissociation at the surface of the alloy. This often results, however, in discoloration and in reduced adhesion in respect of a plastics veneer.

The abstract of the Japanese patent application having the publication number JP 62292774 relates to a method in which a primer containing vinylbenzyl-amino-triazinedithiol, for example (10-acryloyloxydesyloxy)-S-triazine-4,6-dithiol, is applied directly to the surface of an alloy.

DE-A1 198 57 367 describes a means of treating a metal surface, which contains at least 0.001% by weight of a polymerisable monomer. A polymerisable monomer therein has a thiophenecarboxylic acid ester group and a further polymerisable monomer has a phosphoric acid ester group. The monomers are dissolved in an organic solvent.

A disadvantage of the methods described in the two last-mentioned specifications is that some of the substances described are unstable. Furthermore, the metal/polymer bonds made with the aid of the above-described compounds often exhibit an increased susceptibility to hydrolysis and oxidation. Moreover, the described compounds are expensive to produce.

There was therefore a need for a means and a method for the production of metal/polymer bonds that are stable under the conditions described above, which avoid the disadvantages of the prior art.

The present invention was therefore based on the problem of providing a means which enables hydrolysis-stable, strongly adherent metal/polymer bonds to be made while avoiding the need for a large amount of apparatus. Furthermore, the invention was based on the problem of providing a means which enables hydrolysis-stable, strongly adherent metal/polymer bonds to be made and which is also stable under the ambient conditions that usually arise.

The invention was also based on the problem of providing a method of producing metal/polymer bonds that results in hydrolysis-stable, strongly adherent metal/polymer bonds without requiring a large amount of apparatus.

The problems underlying the invention are solved by means and methods as described in greater detail in the text which follows. The present invention therefore relates to an adhesion promoter for metal/polymer composites, at least comprising an alkoxysilane having at least one ethylenically unsaturated group and at least one alkoxysilane having at least one mercapto group or condensation products thereof and at least one organic solvent.

The term “adhesion promoter” in the context of the present text is understood to mean a composition that improves the adhesion between a metal surface and a polymer layer bonded to such a metal surface. The term “improves” relates to a comparison of the adhesion between the metal surface and the polymer layer without adhesion promoter and with adhesion promoter.

The term “metal/polymer composite” in the context of the present invention is understood to mean an article having at least one metal surface which has a strongly adherent bond to at least one polymer surface. The term “strongly adherent” relates to the state in which an adhesive force acts between metal surface and polymer surface.

Within the scope of a preferred embodiment of the present invention, a “metal/polymer composite” as mentioned in the context of the present text is a composite that can be used in dentistry.

An adhesion promoter according to the invention is in principle suitable for improving the adhesion of polymers to any metals. Examples of suitable metals are those of main groups II and III and of sub-groups I, IV, V, VI, VII and VIII of the Periodic Table of the Elements. Also suitable as a constituent of the metal/polymer bonds within the scope of the present invention are corresponding alloys of two or more of the said metals.

Examples of suitable metals include Au, Ag, Pt, Pd, In, Cr, Co, Ti, Al, Mg, Mo, Fe, Ni, Cu, Zn and Sn.

Within the scope of a further embodiment of the present invention, the metals used may be metal alloys, for example the metal compounds commercially available as so-called dental alloys. Suitable alloys comprise, for example, mixtures of two or more of the metals Au, Ag, Pd, Pt, Zn, In, Cu, Ti, Co and Cr. Especially suitable metal alloys are, for example, those having a content of gold of more than about 50% by weight, for example more than about 60%, 70% or 80% by weight, it frequently being possible for such alloys also to have a content of copper of more than about 1% by weight, for example from approximately 2% to approximately 12% by weight. Also suitable are, for example, alloys having a high content of Co or Cr or of both, for example Co/Cr alloys.

Examples of especially suitable metal alloys are those obtainable under the names Albabond® (manufacturer: Heraeus), Mainbond® EH (manufacturer: Heraeus), Galvanogold® (manufacturer: Wieland), Degunorm (manufacturer: Degussa), Wiro-bond C (manufacturer: BEGO) and Wiron 88 (manufacturer: BEGO).

It has been found within the scope of the present invention that in principle the adhesion promoter according to the invention yields, on substantially any metal base, a marked improvement in the adhesion properties of a plastics veneer to the metal surface. It is, however, preferred within the scope of the present invention when the adhesion promoter according to the invention is used on metals or metal alloys having a content in the metal base of metals that are capable of complex formation, for example precious metals or precious-metal-containing alloys. Especially suitable alloys comprise, for example, at least one or a mixture of two or more of the metals Au, Ag, Pd, Pt, Co, Cr, Mo and Ni.

The metal base can in principle be of substantially any shape and can in principle have substantially any surface structure. It is, however, preferred within the scope of the present invention when the metal base has a shape taken from the range of shapes known in the context of dentistry, as in restorative and prosthetic treatment methods.

An adhesion promoter according to the invention is used for the production of a metal/polymer bond. In so doing, the above-described metal base is provided (veneered) with a polymer layer and should exhibit the strongest possible adhesion to that polymer layer.

A polymer layer, as encountered in the metal/polymer bonds described in the context of the present text, is a polymer or a mixture of two or more polymers, such as can be prepared by free radical polymerization. The expression “can be prepared by free radical polymerisation” is understood in the context of the present text as meaning that the polymer finally present in the metal/polymer bond has been polymerised at least in a last step by free-radical polymerisation. This is no obstacle to the polymer's containing in the polymer backbone or in any side chains, or in both, bonds that have been produced by some other method of increasing the molecular weight, for example by polyaddition or by polycondensation.

The polymer designated a constituent of the metal/polymer bond within the scope of the present invention is preferably a polymer the final increase in the molecular weight of which has taken place in contact with the metal base or with the adhesion promoter, described in greater detail below, which is located on the metal base. Within the scope of a further preferred embodiment of the present invention, the polymer designated a constituent of the metal/polymer bond in the context of the present invention is a polymer the final increase in the molecular weight of which has taken place by free-radical polymerisation of free-radical-polymerisable compounds, especially so-called pre-polymers or macromonomers.

Examples of suitable prepolymers and macromonomers are compounds having at least one, preferably at least two, olefinically unsaturated double bond(s). Especially suitable are compounds that can be obtained by reaction of corresponding difunctional compounds with acrylic acid or methacrylic acid or with other suitable compounds having at least one olefinically unsaturated double bond.

Examples of compounds suitable for the preparation of the polymers described within the scope of the present invention are ester acrylates or ester methacrylates or mixtures thereof. Ester acrylates or ester methacrylates are obtainable, for example, by reaction of acrylic acid or methacrylic acid with compounds having at least one OH group or at least one epoxy group by condensation or addition. Suitable compounds having at least one OH group are in principle any mono- or poly-functional alcohols, preferably alcohols having two or more, for example from 2 to 6, especially 2 or 3, OH groups. Suitable alcohols can be of aliphatic or aromatic nature or can contain both building blocks.

There are generally suitable mono- and poly-functional (meth)acrylate monomers, the term “(meth)acrylate” denoting both compounds based on acrylic acid and compounds based on methacrylic acid. Typical members of that class of compounds (described, for example, in DE-A 43 28 960) are alkyl (meth)acrylates, including the cycloalkyl (meth)acrylates, aralkyl (meth)acrylates and 2-hydroxyalkyl (meth)acrylates, for example hydroxypropyl methacrylate, hydroxyethyl methacrylate, isobomyl acrylate, isobornyl methacrylate, butyl glycol methacrylate, acetyl glycol methacrylate, triethylene glycol dimethacrylate, polyethylene glycol dimethacrylate, 2-phenylethyl methacrylate, 2-ethylhexyl methacrylate, cyclohexyl methacrylate, lauryl methacrylate and hexanediol di(meth)acrylate. It is also possible to use long-chain monomers based on bisphenol A and glycidyl methacrylate, which are known from U.S. Pat. No. 3,066,112, or derivatives thereof formed by addition of isocyanates (urethane methacrylates).

Also suitable are compounds of the bisphenol A diethyloxy(meth)acrylate and bis-phenol A dipropyloxy(meth)acrylate type. It is also possible to use the oligoethoxylated and oligopropoxylated bisphenol A diacrylic and dimethacrylic acid esters. Also very suitable are the diacrylic and dimethacrylic acid esters of bis(hydroxymethyl)-tricyclo-[5.2.1.0²⁶]decane mentioned in DE-C 28 16 823 and the diacrylic and dimethacrylic acid esters of compounds of bis(hydroxymethyl)-tricyclo[5.2.1.0²⁶]decane that have been extended by from 1 to 3 ethylene oxide and/or propylene oxide units.

The preparation of corresponding ester acrylates or ester methacrylates is generally known to the person skilled in the art.

Also suitable as prepolymers are, for example, the polyfunctional urethane methacrylates or polyfunctional urethane acrylates already mentioned above. Urethane methacrylates are obtainable by reaction of polyisocyanates with OH-functional acrylates or methacrylates, such as hydroxyethyl acrylate, hydroxypropyl acrylate, hydroxyethyl methacrylate or hydroxypropyl methacrylate. If the polyisocyanate used is a diisocyanate, the product obtained is a urethane dimethacrylate; if a OH-functional acrylate is used, analogously a difunctional acrylate is obtained.

Urethane methacrylates or urethane acrylates have excellent material properties, such as high rigidity or low water absorption. Also possible is the use of a monomer prepared from a combination of triisocyanates or higher functionality polyisocyanates with OH-functional acrylates or methacrylates, such urethane methacrylates or urethane acrylates having a functionality of 3 or higher in respect of olefinically unsaturated double bonds.

Suitable prepolymers or macromonomers have a viscosity of from 10³ to 5×10⁴ mPas, especially of 1×10⁴ mPas (measured with Rheo Stress RS 100, Haake) at a temperature of 20° C., because when those compounds are used for the preparation of corresponding metal/polymer bonds, good consistency is obtained even without dilution of the prepolymers or macromonomers.

Suitable prepolymers or macromonomers have a molecular weight of from approximately 400 to approximately 2500 g/mol, for example from approximately 450 to approximately 1000 g/mol or from approximately 500 to approximately 800 g/mol.

A composition suitable for the preparation of corresponding polymers, in addition to comprising the above-mentioned constituent, may also comprise one or more reactive diluents. The term “reactive diluents” in the context of the present text is to be understood as meaning compounds which act as solvents or diluents for the composition used for the polycondensation and thus reduce the viscosity of the composition, but which also are polymerised into the polymer matrix during polymerisation of the composition, for example during photopolymerisation. For that purpose there are suitable, for example, further monomethacrylates, dimethacrylates and trimethacrylates.

For example, dimethacrylate comonomers, such as triethylene glycol dimethacrylate (“TEGDM”), ethylene glycol dimethacrylate, tetramethylene glycol dimethacrylate, trimethylolpropyl trimethacrylate, 1,6-hexanediol dimethacrylate and 1,3-butanediol dimethacrylate, are suitable as additional constituents of the compositions to be polymerised.

Furthermore, a polymer composition used for polymerisation can comprise further ingredients, such as fillers, photoinitiator systems and coloured pigments.

As fillers it is generally possible to use inorganic fillers. There may be mentioned by way of example quartzes, ground glasses, silica gels and also pyrogenic silicic acids and precipitated silicic acids and granules thereof. It is preferable also to use, at least to some extent, X-ray opaque fillers. They may be, for example, X-ray opaque glasses, that is to say glasses comprising, for example, strontium, barium or lanthanum (e.g. according to U.S. Pat. No. 3,971,754) or some of the filler materials consist of an X-ray opaque additive, such as yttrium trifluoride, strontium hexafluorozirconate or fluorides of rare earth metals (for example according to EP-A-0 238 025). For better incorporation into the polymer matrix it is advantageous for the inorganic fillers to be rendered hydrophobic. Suitable fillers may therefore have been rendered hydrophobic, for, example silanised. The use of silanised filler, in addition to increasing wettability by reducing the polar character, can even enable chemical bonding into the polymer matrix to be achieved. Such a filler acts as additional crosslinking agent and increases rigidity.

Customary hydrophobic agents are silanes, for example trimethoxymethacryloyloxy-propylsilane and trimethoxyglycidylsilane.

Suitable filler materials have preferably an average particle distribution<about 2 μm, especially<about 0.5 μm, and an upper particle limit of about 15 μm, preferably about 7 μm and especially about 2.5 μm.

Especially preferred are mixtures of from 5 to 25% by weight fillers having an average particle size of from 0.02 to 0.06 μm and from 65 to 85% by weight fillers having an average particle size of from 1 to 5 μm.

When a polymer layer described as constituent of a metal/polymer bond in the context of the present text is used as a so-called “opacifier”, the polymer composition used for the preparation of the polymer layer can comprise as fillers, for example, pigments having especially good covering power, more especially titanium dioxide.

As initiators for initiating the polymerisation it is preferable to use those systems which are able to form free radicals within a certain period of time. In the case of one-component compositions, photoinitiators used for that purpose are those able to initiate the polymerisation reaction by irradiation with UV or visible light. A polymer composition intended for polymerisation may comprise as photoinitiators, for example, individual suitable photoinitiators, but it is equally possible for a polymer composition used for polymerisation to comprise initiator systems that include photoinitiators and co-initiators.

Examples of such photoinitiators are benzoin alkyl ethers, benzil ketals, acylphosphine oxides and aliphatic and aromatic 1,2-diketone compounds, for example camphorquinone, it being possible to accelerate the photopolymerisation in a manner known per se by the addition of activators, such as tertiary amines or organic phosphites.

Suitable initiator systems for initiating polymerisation by means of a redox mechanism are, for example, the systems peroxide/amine or peroxide/barbituric acid derivatives and the like. When such initiator systems are used it is advantageous to store an initiator (e.g. peroxide) and a catalyst component (e.g. amine) separately. The two components are then mixed together homogeneously shortly before they are used.

Suitable adjuvants can be, for example, stabilisers, pigments or diluents customarily used in dentistry.

The preparation of the compositions intended for polymerisation is preferably effected by mixing the liquid constituents together, incorporating the initiators (unless they are liquid) therein by stirring and then adding the fillers. Good homogenisation can be obtained, for example, by kneading.

Two-component compositions suitable for polymerisation that are cured by redox mechanisms are so formulated that the essential constituents of the redox initiation system are each incorporated separately into a portion of the two-component preparation. The division of the constituents in the total preparation is governed by the respective storage stabilities and the mixing ratio desired.

The polymerisable compositions are distinguished by a high filler content and thus by associated high strength combined at the same time with good processability.

The polymerisable compositions are usually commercially available in containers such as tubular bags, single- or multi-chamber cartridges or capsules and other application units, for example blister packs or syringes, such as are known in dentistry.

Further suitable polymerisable compositions can also comprise siloxane compounds, such as are described, for example, in WO 01/92271. Reference is expressly made to the disclosure of the said specification, and the part of the disclosure relating to the siloxane compounds is regarded as a component of the disclosure of the present text.

The thickness of a polymer layer, in the context of the metal/polymer bonds described herein, may vary within wide limits. The lower limit for the thickness of a suitable polymer layer is about 20 μm, while the upper limit is about 5 mm.

A metal/polymer bond described in the context of the present text is produced according to the invention using an adhesion promoter that improves the adhesion between metal and polymer layer. An adhesion promoter according to the invention comprises at least one alkoxysilane having at least one olefinically unsaturated double bond and at least one alkoxysilane having at least one mercapto group or condensation products thereof.

An “alkoxysilane” in the context of the present invention is to be understood as being a compound having at least one functional group of the general formula I

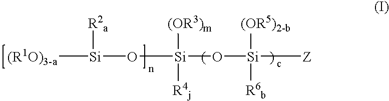

wherein each of the radicals R¹ to R⁶ independently of the others is a linear or branched, saturated or unsaturated hydrocarbon radical having from 1 up to about 24 carbon atoms, a saturated or unsaturated cycloalkyl radical having from 4 up to about 24 carbon atoms or an aryl radical having from 6 up to about 24 carbon atoms, n, m and j are each a whole number from 0 to 3, the sum of m+n+j being 3, a is a whole number from 0 to 3, b is a whole number from 0 to 2 and c is a number from 0 to 8 and Z is a radical carrying at least one olefinically unsaturated double bond or at least one mercapto group or at least one olefinically unsaturated double bond and at least one mercapto group.

Within the scope of a preferred embodiment of the present invention, n, j and c are each 0 and m is 3, the radicals R³ being, independently of one another, CH₃ or CH₃—CH₂.

A compound suitable for use within the scope of the present invention and designated an “alkoxysilane” can have an alkoxysilyl group of the general formula I or a plurality of alkoxysilyl groups of the general formula I. Within the scope of a preferred embodiment of the present invention, a compound designated an alkoxysilane has 1 or 2 alkoxysilyl groups of the general formula I, preferably one alkoxysilyl group of the general formula I.

An adhesion promoter according to the invention comprises at least one compound having at least one alkoxysilyl group and a radical Z which carries at least one olefinically unsaturated double bond. The radical Z can be chosen substantially as desired, provided it carries at least one olefinically unsaturated double bond.

Examples of suitable compounds are those which carry the olefinically unsaturated double bonds linked directly to the Si atom via a carbon chain, for example vinyl trimethoxysilane or vinyl triethoxysilane.

However, the radical Z may be, for example, a radical which carries at least one acryloyl or methacryloyl group. Suitable radicals Z are, for example, acryloyloxyethyl, acryloyloxypropyl, acryloyloxybutyl, acryloyloxypentyl or acryloyloxyhexyl radicals or acryloyloxyalkyl radicals having more than 6 carbon atoms, for example having from 7 to 20 or 8 to 14 carbon atoms, or the corresponding methacryloyl compounds. The acryloyl- or methacryloyl-oxyalkyl radicals can be linear or branched, but are preferably linear.

Alkoxysilanes having at least one olefinically unsaturated double bond that are especially suitable according to the invention are vinyl trimethoxysilane, vinyl triethoxysilane, trimethoxysilylethyl (meth)acrylate, triethoxysilylethyl (meth)acrylate, ethoxydimethoxysilylethyl (meth)acrylate, methoxydiethoxysilylethyl (meth)acrylate, trimethoxysilylpropyl (meth)acrylate, triethoxysilylpropyl (meth)acrylate, ethoxydimethoxysilylpropyl (meth)acrylate, methoxydiethoxysilylpropyl (meth)acrylate, trimethoxysilylbutyl (meth)acrylate, triethoxysilylbutyl (meth)acrylate, ethoxydimethoxysilylbutyl (meth)acrylate, methoxydiethoxysilylbutyl (meth)acrylate, trimethoxysilylpentyl (meth)acrylate, triethoxysilylpentyl (meth)acrylate, ethoxydimethoxysilylpentyl (meth)acrylate, methoxydiethoxysilylpentyl (meth)acrylate, trimethoxysilylhexyl (meth)acrylate, triethoxysilylhexyl (meth)acrylate, ethoxydimethoxysilylhexyl (meth)acrylate and methoxydiethoxysilylhexyl (meth)acrylate or mixtures of two or more thereof.

In addition to comprising an alkoxysilane having at least one olefinically unsaturated double bond, an adhesion promoter according to the invention also comprises at least one alkoxysilane having at least one mercapto group. Suitable alkoxysilanes carrying mercapto groups likewise follow the general formula I, the radical Z carrying at least one mercapto group.

Examples of suitable compounds are therefore those which carry the mercapto group linked to the Si atom via a carbon chain, for example mercaptoethyl trimethoxysilane, mercaptoethyl triethoxysilane, mercaptopropyl trimethoxysilane, mercaptopropyl triethoxysilane, mercaptobutyl trimethoxysilane, mercaptobutyl triethoxysilane, mercaptopentyl trimethoxysilane, mercaptopentyl triethoxysilane or the corresponding higher homologues having up to about 20 carbon atoms, for example from about 6 to about 12 carbon atoms, in the alkylene radical.

Especially suitable as constituent of an adhesion promoter according to the invention within the scope of the present invention are mercaptopropyl trimethoxysilane and mercaptopropyl triethoxysilane or a mixture thereof.

An adhesion promoter according to the invention comprises the two components described above, that is to say an alkoxysilane having at least one olefinically unsaturated double bond and an alkoxysilane having at least one mercapto group, in a total amount of up to approximately 70% by weight, for example in an amount of from approximately 0.1 to approximately 10% by weight or from approximately 0.2 to approximately 5% by weight, for example from approximately 0.4 to approximately 3% by weight or from approximately 0.7 to approximately 2% by weight, based on the total adhesion promoter.

The ratio of alkoxysilane having at least one olefinically unsaturated double bond to alkoxysilane having at least one mercapto group is from approximately 1:10 to approximately 10:1, especially from approximately 1:2 to approximately 2:1 or from approximately 1:1.2 to approximately 1.2:1.

It is also possible within the scope of the present invention, and it is also provided therein, that the two constituents necessarily present in an adhesion promoter according to the invention are contained in the adhesion promoter not in their monomolecular form described above but in the form of a condensation product. This is the case especially when an adhesion promoter according to the invention, in addition to comprising the two types of compound described above, also comprises at least one further compound that initiates or accelerates the condensation of the compounds having alkoxysilyl groups contained in the adhesion promoter. In such a case, there may be at least partial condensation of the compounds having alkoxysilyl groups contained in the adhesion promoter. This does not, however, affect the effectiveness of the adhesion promoters according to the invention.

In addition to the two types of compound having alkoxysilyl groups described above, an adhesion promoter according to the invention also comprises at least one organic solvent. A suitable organic solvent is in principle any solvent that dissolves the compounds contained in the adhesion promoter according to the invention and that evaporates sufficiently quickly after the adhesion promoter has been applied to the metal surface. It is preferably a solvent having a boiling point of less than approximately 100° C. Suitable solvents are, for example, ethanol, propanol, isopropanol, acetone, methyl ethyl ketone, methyl acetate and ethyl acetate, or a mixture of two or more thereof.

Suitable solvents have a water content of less than about 1% by weight, especially less than about 0.5% by weight or less than about 0.1% by weight.

The content of solvent or solvent mixture in the adhesion promoter according to the invention is, based on the total adhesion promoter, from approximately 70 to approximately 99.9% by weight, especially from approximately 85 to approximately 99.5% by weight.

In addition to comprising the alkoxysilanes mentioned above and an organic solvent or solvent mixture, an adhesion promoter according to the invention can also comprise an acid. Suitable acids are in principle inorganic acids, such as hydrochloric acid, nitric acid, sulfuric acid, phosphoric acid or phosphorous acid. Within the scope of the present invention it is also possible, however, for an adhesion promoter according to the invention to comprise an organic acid or a mixture of two or more organic acids. In principle, suitable acids are any organic compounds which exhibit an acidic action in the adhesion promoter, especially suitable compounds being organic carboxylic acids or phosphonic acids, such as acetic acid, tartaric acid and maleic acid. Also suitable are those compounds which, on the one hand, exhibit an acidic action and, on the other hand, can be incorporated by way of a suitable functional group into the polymer layer to be applied to the metal surface. Such compounds are termed “acidic monomers” in the context of the present text.

Especially suitable as acidic monomers are phosphoric acid esters that contain one or more olefinically unsaturated double bonds. Such compounds can be obtained, for example, from OH-group-carrying alkylphosphates by reaction with carboxylic acids or epoxides that have one or more olefinically unsaturated double bonds. Especially suitable as constituent of the adhesion promoters according to the invention are the esters of acrylic acid or methacrylic acid with OH-group-carrying linear or branched alkyl phosphates, such as acryloyloxyethyl phosphate, acryloyloxypropyl phosphate, acryloyloxybutyl phosphate, acryloyloxypentyl phosphate, acryloyloxyhexyl phosphate, methacryloyloxyethyl phosphate, methacryloyloxypropyl phosphate, methacryloyloxybutyl phosphate, methacryloyloxypentyl phosphate, methacryloyloxyhexyl phosphate, or the corresponding higher homologues having up to 20 carbon atoms, for example from about 7 to about 10 or about 12 carbon atoms, in the carbon chain, for example methacryloyloxydecyl phosphate.

Within the scope of an adhesion promoter according to the invention the above-mentioned acids may be present on their own or as a mixture of two or more of the mentioned acids.

When an adhesion promoter according to the invention comprises an acid or a mixture of two or more acids, the content of acid or acids in the adhesion promoter is from approximately 0.5 to approximately 25% by weight, especially from approximately 1 to approximately 10% by weight or from approximately 2 to approximately 8% by weight.

An adhesion promoter according to the invention may, if necessary, comprise one or more additives in addition to the compound types already described. Suitable additives are, for example, crosslinking agents.

Suitable crosslinking agents are, for example, compounds having two or more olefinically unsaturated double bonds. Especially suitable are the esters of divalent or polyvalent alcohols with acrylic acid and methacrylic acid already described above in the context of the present text, such as ethylene glycol di(meth)acrylate, propylene glycol di(meth)acrylate, butanediol di(meth)acrylate, hexanediol di(meth)acrylate, triethylene glycol di(meth)acrylate, tetraethylene glycol di(meth)acrylate, neopentyl glycol di(meth)acrylate, trimethylolpropane tri(meth)acrylate or (meth)acrylate esters of aromatic polyfunctional alcohols, especially the (meth)acrylate esters of bisphenol A. An adhesion promoter according to the invention can comprise one of the mentioned crosslinking agents on its own or a mixture of two or more of the mentioned crosslinking agents. The content of crosslinking agent(s) in an adhesion promoter according to the invention is from approximately 0.1 to approximately 30% by weight, especially from approximately 0.5 to approximately 20% by weight or from approximately 1 to approximately 15% by weight or from approximately 2 to approximately 20% by weight. Within the scope of a preferred embodiment of the present invention an adhesion promoter according to the invention has, for example, the following composition:

from 0.1 to 20% by weight of an alkoxysilane having at least one olefinically unsaturated double bond

from 0.1 to 10% by weight of an alkoxysilane having a mercapto group

from 0 to 10% by weight of crosslinking agent

from 0.1 to 20% by weight of acid or acidic monomer and

from 79.8 to 99.7% by weight solvent.

A formulation suitable as adhesion promoter contains, for example, 5% by weight γ-methacryloyloxypropyl trimethoxysilane, 2% by weight trimethoxysilyl propanethiol, 0.5% by weight 0.1N HCl and 92.5% by weight acetone.

An adhesion promoter according to the invention can, as already described above, provide the necessary components and the optional components of the adhesion promoter in the form of a single solution. It is, however, also envisaged within the scope of the present invention that an adhesion promoter according to the invention will provide the compounds required for synthesising the adhesion-promoting layer in the form of a kit comprising two or more separately contained components (solutions).

It has in principle been found satisfactory when the adhesion promoter consists of at least two components A and B, wherein component A comprises at least one alkoxysilane, but preferably all the alkoxysilanes contained in the adhesion promoter, and component B comprises an acid or an acidic monomer.

The present invention therefore relates also to an adhesion promoter, at least comprising two separately contained components A and B, wherein

a) component A comprises at least one alkoxysilane having at least one olefinically unsaturated double bond and at least one alkoxysilane having at least one mercapto group or condensation products thereof and

b) component B comprises at least one acid or at least one acidic monomer or a mixture of two or more thereof.

The expression “separately contained” in the context of the present invention covers the situation where the components belonging to a multiple-component adhesion promoter according to the invention are physically separated from one another so that the individual components cannot become mixed together. This can mean, for example, storage in physically separate containers, for example storage in bottles. It is also possible, however, for the different components to be stored in a single container which, for example, has different chambers separated from one another by partitions and the individual components of the adhesion promoter according to the invention are stored in the respective chambers.

The form of delivery of a multicomponent adhesion promoter according to the invention can be such that the individual components are each freely available. It is, however, also provided within the scope of the present invention that the individual components of a multicomponent adhesion promoter according to the invention are delivered together, for example in a suitable container having a plurality of chambers or in separate containers which, for example, are linked to one another in suitable packaging, e.g. a blister pack.

Within the scope of a preferred embodiment of the present invention, a multicomponent adhesion promoter according to the invention includes two components A and B, wherein component A comprises the alkoxysilanes present within the scope of the adhesion promoter according to the invention and component B comprises an acid or an acidic monomer or a mixture thereof.

Within the scope of a further preferred embodiment of the present invention, component A comprises a solvent or a mixture of two or more solvents. Suitable solvents include the solvents already mentioned above in this text. It is advantageous for the storage stability of the adhesion promoter according to the invention when a solvent present in component A has a water content of less than approximately 0.1% by weight, especially less than approximately 0.05% by weight.

Within the scope of a further preferred embodiment of the present invention, a suitable component A comprises, for example,

from approximately 0.5 to approximately 30% by weight of at least one alkoxysilane having an olefinically unsaturated double bond

from approximately 0.5 to approximately 20% by weight of at least one alkoxysilane having at least one mercapto group and

from approximately 50 to approximately 99% by weight of a solvent or solvent mixture.

Corresponding compositions suitable as component B of an adhesion promoter according to the invention comprise at least one acid or an acidic monomer. Within the scope of a preferred embodiment of the present invention, a composition suitable as component B also comprises at least one solvent. A suitable component B can have, for example, the following composition:

from approximately 0.5 to approximately 50% by weight, especially from approximately 5 to approximately 40% by weight, of an acid or an acidic monomer and

from approximately 50 to approximately 99.5% by weight, especially from approximately 60 to approximately 80% by weight, of a solvent or solvent mixture.

The adhesion promoters described in the context of the present invention are suitable for the production of metal/polymer bonds.

That is done in principle by providing a metal surface with an adhesion promoter according to the invention. The present invention therefore relates also to a method of treating a metal surface, in which a metal surface is provided with an adhesion promoter according to the invention.

The method according to the invention can be carried out in principle in any way, provided that, when the method is complete, a layer of an adhesion promoter according to the invention is present on the metal surface. If, for example, within the scope of the method according to the invention, a one-component adhesion promoter is used, the method according to the invention can be carried out by applying the adhesion promoter to the metal surface in one or more operations. The application is preferably effected in a single operation.

For application there are in principle suitable any methods of application by which a sufficiently thick layer of the adhesion promoter can be applied to the metal surface. Suitable methods of application are, for example, brush application, roller application, knife application and spraying. Within the scope of a preferred embodiment of the present invention, a brush is used to apply the adhesion promoter according to the invention to the metal surface. After the adhesion promoter has been applied to the metal surface, preferably a period is allowed to elapse until the solvent contained in the adhesion promoter has essentially largely evaporated, that is to say only a maximum of about 5% by weight, but preferably less than about 1% by weight, of the solvent originally present remains in the layer of adhesion promoter.

When a metal surface is to be treated with a multicomponent adhesion promoter according to the invention, various process steps are suitable. For example, the metal surface can be treated first with component A and then with component B. A reverse procedure is also possible, however, that is to say the metal surface is treated first with component B and only subsequently with component A. Drying steps, in which some or all of the solvent contained in the component in question is allowed to evaporate, can be introduced between the individual treatment steps.

Within the scope of the present invention it is likewise possible, however, for the treatment with a multicomponent adhesion promoter according to the invention to be carried out in substantially the same way as for the one-component adhesion promoter. For that purpose, the individual components of the multicomponent adhesion promoter are mixed together in the desired ratio prior to application to the metal surface and the mixture is applied to the metal surface.

The metal/polymer bonds already described can then be produced on the metal surfaces so treated. For that purpose, a polymerisable composition, as already described above in the context of the present text, is applied to the pretreated metal surface and polymerised. Suitable procedures are known to the person skilled in the art. Within the scope of the invention it is possible to introduce one or more intermediate steps prior to the application of the final polymer layer; for example before the polymer layer is applied it may be preferable for an opacifier, such as is customarily used in dentistry and is known to the person skilled in the art, to be applied to the metal surface pretreated with the adhesion promoter and polymerised.

An “opacifier” in the context of the present invention is understood to be a polymerisable composition which is used essentially for hiding the colour of the metal substrate. In view of its suitability as a polymer layer in the context of the present text, a polymer composition suitable for use as an “opacifier” is likewise covered by the term “polymer layer”, as used in connection with the metal/polymer bonds described herein. A metal/polymer bond, as described in the context of the present invention, can therefore also consist of a layer of opacifier applied to a metal surface with the aid of an adhesion promoter according to the invention. Suitable opacifiers are known to the person skilled in the art.

The present invention therefore relates also to a method of producing a metal/polymer bond in which a metal surface treated in accordance with a method of the invention is coated with a polymerisable composition and the polymerisable composition is then polymerised.

The present invention relates also to the use of an alkoxysilane having at least one mercapto group or to the use of a mixture comprising at least one alkoxysilane having at least one olefinically unsaturated double bond and at least one alkoxysilane having at least one mercapto group or a condensation product of a mixture of two or more of the said compounds as adhesion promoter for metal/polymer bonds.

The invention will be described in greater detail below by way of examples.

### EXAMPLES:

The following two-component adhesion promoters were prepared:

Adhesion promoter 1:

| | |
|---|---|
| Component A: | 2 ml γ-methacryloyloxypropyl trimethoxysilane |
| | 1 ml trimethoxysilyl propanethiol |
| | 50 ml acetone |
| Component B: | 5 ml 50% phosphoric acid |
| | 50 ml acetone |

Adhesion promoter 2:

| | |
|---|---|
| Component A: | 2 ml γ-methacryloyloxypropyl trimethoxysilane |
| | 1 ml trimethoxysilyl propanethiol |
| | 100 ml acetone |
| Component B: | 10 ml methacryloyloxyethyl phosphate |
| | 100 ml acetone |

For the treatment of the metal surfaces, the surfaces of suitable metal samples (dimensions: 20×10×2 mm) were first corundum-blasted. Then component A of adhesion promoter 2 was applied. After evaporation of the solvent, component B of adhesion promoter 2 was applied. In an intermediate step, a methacrylate-based opacifier was applied to the adhesion promoter layer and polymerised.

Subsequently thereto, a veneer plastics was applied. For that purpose, a metal ring (diameter: 5 mm, height: 2 mm) was applied to the metal surface which had been pretreated with adhesion promoter and opacifier and the metal ring was filled with the composition to be polymerised. Polymerization was then initiated by irradiation with UV light. When the metal ring was removed, a cylinder of plastics having a diameter of 5 mm and a height of 2 mm was left on the treated metal surface.

The metal/plastics bonds so produced were stored in distilled water for 24 hours and then tested for bond strength in a shear strength under compression test using a Zwick 1435 testing machine (rate of advance of the testing machine: 1 mm min⁻¹).

In order to simulate the stress load on the bonds occurring under oral conditions over a period of years, some of the bonds were artificially aged. This was achieved either by boiling (24 hours) in distilled water or by temperature change stresses (25,000 temperature stress changes, TSC, t₁=5° C., t₂=55° C.). The bond strengths thereby obtained are listed in Tables 1 and 2.

TABLE 1
Metal/plastics bond, dental plastics:
Arabesk Top, opacifier: Targis-Opaker

| | Shear strength [MPa] | | | | | |
|---|---|---|---|---|---|---|
| | Blank value | | | Adhesion promoter 2 | | |
| | 24 h | 25000 | boiled | 24 h | 25000 | boiled |
| Dental alloy | 37° C. | TSC | 1 d | 37° C. | TSC | 1 d |
| Albabond | 9.9 | 4.7 | 5.4 | 28.3 | 26.4 | 29.5 |
| Mainbond EH | 12.0 | 5.3 | 4.8 | 29.7 | 27.2 | 28.4 |
| Galvanogold | 8.2 | 3.5 | 3.0 | 26.3 | 24.8 | 25.4 |
| Degunorm | 12.8 | 5.0 | 5.4 | 28.2 | 29.3 | 28.7 |
| Titanium | 12.6 | 7.3 | 6.8 | 32.2 | 30.5 | 31.5 |
| Wirobond C | 10.4 | 4.4 | 5.1 | 25.8 | 24.5 | 23.6 |
| Wiron 88 | 9.1 | 4.2 | 4.9 | 26.3 | 25.2 | 25.4 |
| Aluminium | 4.2 | 1.5 | 2.4 | 22.3 | 23.6 | 24.0 |
| (non-blasted) | | | | | | |
| Magnesium | 3.5 | n.d. | n.d. | 21.5 | 18.3 | 17.9 |
| (non-blasted) | | | | | | |

The blank value was determined using metal surfaces solely corundum-blasted.
n.d. = not determined, because the bond disintegrated

TABLE 2
Metal/plastics bond, metal alloy:
Degunorm, opacifier: Targis-Opaker

| | Shear strength [MPa] | | | | | |
|---|---|---|---|---|---|---|
| | Blank value | | | Adhesion promoter 2 | | |
| | 24 h | 25000 | boiled | 24 h | 25000 | boiled |
| Dental plastics | 37° C. | TSC | 1 d | 37° C. | TSC | 1 d |
| Sinfony | 11.4 | 5.5 | 5.3 | 27.2 | 26.5 | 25.6 |
| Art-Glass | 10.2 | 4.5 | 5.0 | 26.1 | 24.3 | 24.0 |
| Targis | 10.8 | 4.8 | 5.2 | 27.6 | 26.0 | 25.2 |
| Z 100 | 13.5 | 7.5 | 6.9 | 29.8 | 28.0 | 29.2 |
| Prodigy | 12.5 | 6.2 | 5.8 | 26.7 | 27.0 | 26.1 |
| Arabesk Top | 12.8 | 5.0 | 5.4 | 28.2 | 29.3 | 28.7 |

For a further examination of the effectiveness of surface treatment with an adhesion promoter according to the invention, two metal surfaces were treated with an adhesion promoter according to the invention and then adhesively bonded to a dental plastics. The treatment of the surface was carried out analogously to the procedure already described above. The overlap length of the adhesive bond was 10 mm, the bonded surface area was 100 mm². The adhesive bonds were then stored in distilled water for 24 hours and then boiled in distilled water for five days.

Table 3 shows the shear strength under tension values obtained from the adhesive bonding of two dental alloys.

TABLE 3

| Shear strength [MPa] | |
|---|---|
| | Adhesion |
| Blank value | promoter 2 |

| | 24 h | boiled | 24 h | boiled |
|---|---|---|---|---|
| Dental plastics | 37° C. | 5 d | 37° C. | 5 d |
| Compolute | 11.3 | 6.1 | 21.4 | 19.1 |
| Bifix | 10.8 | 5.2 | 19.3 | 17.5 |
| Multilink | 11.2 | 5.8 | 20.4 | 18.3 |
| Twinlook | 10.4 | 5.2 | 19.2 | 18.0 |

The shear strength under compression values according to Tables 1 and 2 show that after 24 hours' storage in water at 37° C. a significantly higher bond strength is achieved with a metal surface pretreated in accordance with the invention than with an untreated, solely corundum-blasted surface. Artificial ageing of the bonds, both by boiling and by temperature change stresses, renders the differences between the treated and untreated surfaces even clearer. Whereas the bond strength of the untreated bonds falls to approximately 50% of the initial strength, the bonds in accordance with the present invention exhibited no significant reduction in bond strength.

The treatment in accordance with the invention of dental alloys of very different compositions, which include precious metal alloys and non-precious metal alloys, also makes it clear that the adhesion-promoting effects of the adhesion promoter according to the invention are alloy-independent.

The adhesive bonds listed in Table 3 exhibit behaviour analogous to the bonds already described. On the untreated surface, the measured values likewise fall to about half the initial strength on boiling, whereas after treatment with an adhesion promoter according to the invention only a very slight fall in bond strength occurs.

The present invention therefore provides an adhesion promoter with which a strongly adherent, moisture-stable and hydrolysis-resistant bonded layer can be applied to the surfaces of alloys, which layer is suitable for an extremely wide variety of bond combinations and accordingly is not limited to use in dentistry.

An advantageous use of the adhesion promoter according to the invention for the production of bonded layers is provided also for lacquer coatings on aluminium and magnesium sheets, in mechanical engineering and vehicle bodywork construction. The durability of the lacquer coating or adhesive bond is markedly improved even under conditions of extreme moisture.

1. An adhesion promoter for metal/polymer composites, at least comprising an alkoxysilane having at least one olefinically unsaturated double bond and at least one alkoxysilane having at least one mercapto group or condensation products thereof and at least one organic solvent.

2. An adhesion promoter according to claim 1, wherein the alkoxysilane having at least one olefinically unsaturated double bond is selected from the group consisting of vinyl trimethoxysilane, vinyl triethoxysilane, γ-methacryloyloxypropyl trimethoxysilane, methacrylic acid trimethylsilyloxyethyl ester, methacrylic acid tris-trimethylsilyloxysilylpropyl ester, trimethoxysilyl propanethiol and triethoxysilyl propanethiol, a mixture of two or more thereof, and a condensation product of two or more thereof.

3. An adhesion promoter according to claim 1, further comprising at least one acid or an acidic monomer or a mixture of two or more thereof.

4. An adhesion promoter according to claim 1, further comprising at least one organic acid having at least one olefinically unsaturated double bond.

5. An adhesion promoter according to claim 1, wherein the organic solvent is a solvent having a boiling point of less than 100° C.

6. An adhesion promoter, at least comprising two separately contained components A and B, wherein
a) component A comprises at least one alkoxysilane having at least one olefinically unsaturated double bond and at least one alkoxysilane having at least one mercapto group or condensation products thereof and at least one solvent and
b) component B comprises at least one acid or at least one acidic monomer or a mixture of two or more thereof and at least one solvent.

7. An adhesion promoter according to claim 6, wherein component A or component B or both comprise a solvent or solvent mixture.

8. An adhesion promoter according to claim 6, wherein component A comprises
a) from 0.5 to 30% by weight of at least one alkoxysilane having an olefinically unsaturated double bond
b) from 0.5 to 20% by weight of at least one alkoxysilane having at least one mercapto group and
c) from 50 to 99% by weight of a solvent or solvent mixture.

9. An adhesion promoter according to claim 6, wherein component B comprises
a) from 0.5 to 50% by weight of an acid or an acidic monomer and
b) from 50 to 99.5% by weight of a solvent or a solvent mixture.

10. A method of treating a metal surface, in which a metal surface is provided with an adhesion promoter according to claim 1.

11. A method according to claim 10, wherein an adhesion promoter according to claim 6 is used.

12. A method according to claim 11, wherein the metal surface is treated first with component A and then with component B.

13. A method of producing a metal/polymer bond, in which a metal surface treated in accordance with a method according to claim 10 is coated with a polymerisable composition and the polymerisable composition is then polymerised.

14. A method of using an alkoxysilane having at least one mercapto group or a mixture comprising at least one alkoxysilane having at least one olefinically unsaturated double bond and at least one alkoxysilane having at least one mercapto group or a condensation product of a mixture of two or more of the said compounds as adhesion promoter for metal/polymer bonds.

15. A method according to claim 10, wherein an adhesion promoter according to claim 7 is used.

16. A method according to claim 10, wherein an adhesion promoter according to claim 8 is used.

17. A method according to claim 10, wherein an adhesion promoter according to claim 9 is used.

18. A method of producing a metal/polymer bond, in which a metal surface treated in accordance with a method according to claim 11 is coated with a polymerisable composition and the polymerisable composition is then polymerised.

19. A method of producing a metal/polymer bond, in which a metal surface treated in accordance with a method according to claim 12 is coated with a polymerisable composition and the polymerisable composition is then polymerised.
